(19) United States
(12) Patent Application Publication
(10) Pub. No.: US 2020/0133968 A1
(43) Pub. Date: Apr. 30, 2020

(54) SUMMARIZATION OF ORIGINAL WORKS USING TEXT ENTAILMENT

(71) Applicant: Primer Technologies, Inc., San Francisco, CA (US)

(72) Inventors: John Neil Bohannon, San Francisco, CA (US); Oleg Vasilyev, Palo Alto, CA (US)

(21) Appl. No.: 16/667,136

(22) Filed: Oct. 29, 2019

Related U.S. Application Data
(60) Provisional application No. 62/752,185, filed on Oct. 29, 2018.

(51) Int. Cl. G06F 16/34; G06F 17/27; G06F 16/338; G06F 17/22

(52) U.S. Cl. CPC G06F 16/345; G06F 17/2247; G06F 16/338; G06F 17/2785

(57) ABSTRACT

The technology disclosed herein improves upon computing systems that summarize original works by using text entailment. In a particular implementation, a method provides, processing a first original work using a text entailment algorithm. The text entailment algorithm outputs passages of the first original work that are most informative relative to other passages. The method further includes, combining the passages into a summary of the first original work and presenting the summary to a user.

### RELATED APPLICATIONS

This application is related to and claims priority to U.S. Provisional Patent Application 62/752,185, titled “SUMMARIZATION OF LITERARY WORKS USING TEXT ENTAILMENT,” filed Oct. 29, 2018, and which is hereby incorporated by reference in its entirety.

### TECHNICAL BACKGROUND

Summarizations of text-based works, such as novels, textbooks, etc., can be helpful for informing people about a work without having to read the entire work. For instance, someone may read a summary for a novel in order to determine whether they would like to read the entire novel. Alternatively, someone may want to catchup on previous books in a series before reading a new book in a series without having to reread those previous books. Of course, many other circumstances exist that would also benefit from such summarizations. Typically, unless you are the author of a work, a person must read the entire work to be able to adequately summarize that work. As such, especially in situations where a large number of works require summarization, a large number of man hours would be required to both read the original works and write the summarizations thereof.

### Overview

The technology disclosed herein enables summarization of original works by using text entailment. In a particular implementation, a method provides, processing a first original work using a text entailment algorithm. The text entailment algorithm outputs passages of the first original work that are most informative relative to other passages. The method further includes, combining the passages into a summary of the first original work and presenting the summary to a user.

In some examples, the method further includes receiving summary parameters that are used as a basis for combining the passages into the summary. In those examples, the summary parameters may include a limit on the length of the summary.

In some examples, the method includes organizing the passages into an entailment tree structure connecting hypothesis passages to text passages. In those examples, hypothesis and text passage combinations that are nearer to a root node of the tree may be less detailed than hypotheses and text passage combinations that are farther down from the root node. Also, combining the passages into the summary may include, for a shorter summary, selecting one or more of the hypothesis and text passage combinations that are nearer to the root node and, for a longer summary, selecting one or more of the hypothesis and text passage combinations that are farther down the root node. Combining the passages into the summary may also include appending selected hypothesis and text passage combinations to one another and other selected hypothesis and text passages and adding punctuation to the selected hypothesis and text passages.

In some examples, the method includes, before processing the first original work, converting the first original work from an audio format to a text format. IN those examples, the method may include converting the summary from the text format to the audio format before presenting the summary.

### BRIEF DESCRIPTION OF THE DRAWINGS

FIG. 1 illustrates an implementation for summarizing an original work using text entailment.

FIG. 2 illustrates an operation to summarize an original work using text entailment.

FIG. 3 illustrates an operational scenario for summarizing an original work using text entailment.

FIG. 4 illustrates a tree structure for summarizing an original work using text entailment.

FIG. 5 illustrates an operation to summarize an original work using text entailment.

FIG. 6 illustrates a computing architecture for summarizing an original work using text entailment.

### DETAILED DESCRIPTION

Text-based works can vary greatly in language style, which makes them difficult computer-based summarization systems to summarize using traditional summarization techniques, such as extractive natural language processing (NLP) summarization techniques. While it may make sense that the language style used for older works would be very different than the language style used for more contemporary works, even two contemporary works can differ in language style enough to prevent the computer automated generation of a useful summary. Even if a method of summarization, such as abstractive summarization, could be trained for a given language style, that method would have to be retrained to each language style.

The summarization systems herein create useful summaries by employing a text entailment algorithm. Rather, than creating a summary from scratch, a text entailment algorithm is able to determine which passages in an original work are the most informative. These identified passages are then combined to form a summary. In some cases, the summary may be considered a montage of the identified passages. Using passages from the original work itself to form the summary allows the summarization service to generate summaries regardless of language style.

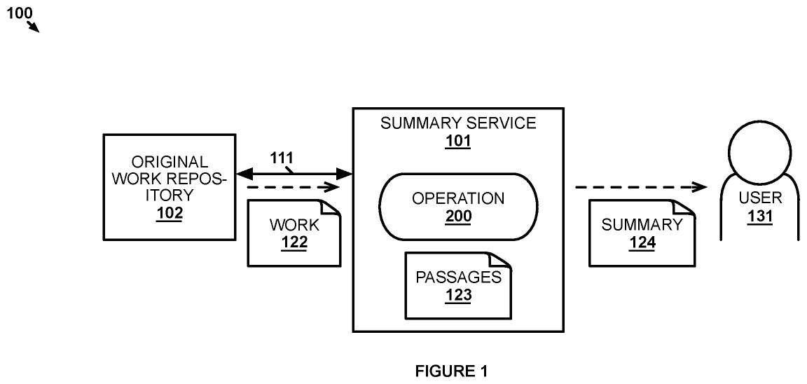

FIG. 1 illustrates implementation 100 for summarizing an original work using text entailment. Implementation 100 includes summary service 101 and original work repository 102. Summary service 101 may be a user device interacting with user 131 directly (e.g., personal computer, tablet, smartphone, information kiosk, advertisement display, etc.), may be a system in connection with a user device operated by user 131 (e.g., a server connected over a communication network), or may be some combination thereof.

In operation, summary service 101 retrieves one or more original works from original work repository 102 for summarization and presentation to user 131. Original work repository 102 communicates with summary service 101 over communication link 111, which may be a direct link or may include intervening networks, systems, and/or devices. Original work repository 102 comprises one or more computer readable storage media, such as a hard disk drive, flash storage, or other type of data storage media. Original work repository 102 may further include processing and communication circuitry necessary to manage data storage and exchanged data over communication link 111. In some examples, original work repository 102 may be incorporated into summary service 101 (e.g., summary service 101 may store data comprising original works on an internal data storage device).

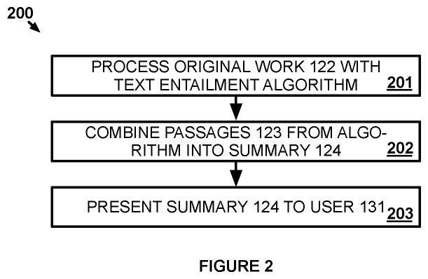

FIG. 2 illustrates operation 200 of computing environment 100 to select a subsequent offer for presentation to a user. In operation 200, summary service 101 processes original work 122 using a text entailment algorithm (201). Original work 122 may be retrieved from original work repository 102 alone or along with other original works to be processed in parallel or otherwise. Original work 122 may comprise any long form text (i.e., text long enough to warrant summarization), whether it be fiction or non-fiction, that is used as the basis for summarization (i.e., it is a work from which summary 124 originates, not necessarily an original work relative to other works). As such, original work 122 may be a novel, technical manual, textbook, white paper, long legal documents, or some other type of long form text. In some examples, original work 122 may be obtained from converting audio (e.g., from a video or audio work) to text.

The text entailment algorithm outputs passages 123 of original work 122 work that are most informative relative to other passages. A passage may be any partition of text, such as one or more words, sentences, paragraphs, pages, etc. Essentially, text entailment algorithms identify a relation between two passages of text. One passage is considered the “text” with the other passage is considered the “hypothesis.” The hypothesis is determined by the text entailment algorithm to be something that readers of the “text” passage would agree is also true. For example, the “text” passage may recite that “a tornado went through the town of Smallville” and the “hypothesis” passage may recite that “the town of Smallville was damaged.” Readers of the “text” passage would agree that, if a tornado went through Smallville, then the town was likely damaged, as asserted by the “hypothesis” passage. A “hypothesis” passage may then be identified as being the “text” passage to another “hypothesis” passage in the original work. In some cases, a single “text” passage may be the basis for multiple “hypothesis” passages. Likewise, a single “hypothesis” passage may stem from multiple “text” passages. Eventually, a most informative “hypothesis” passage about a particular event, or plot point, in original work 122, would be identified (e.g., a passage that cannot be used as the “text” passage for another “hypothesis” passage) and included in passages 123.

In some examples, passages 123 may form an entailment tree that is generated as each “text” and “hypothesis” passage is identified by the text entailment algorithm. As noted above, after a first “hypothesis” passage is identified from one or more “text” passages, that “hypothesis” passage can be used as the “text” passage to one or more other “hypothesis” passages. The ancestry of the “hypothesis” passages may be tracked by summary service 101 to generate a tree of “hypothesis” passages and the “text” passages from which those “hypothesis” passages were determined. Some branches of the tree may even converge if multiple “text” passages (which may themselves be “hypothesis” passages for other “text” passages) end up satisfying a same “hypothesis” passage. “Hypothesis” passages that are further along in the tree would be more informative passages because they are derived from more “text” passages farther up in the tree.

Summary service 101 then combines passages 123 into summary 124 of original work 122 (202). To combine passages 123 into summary 124, summary service 101 may simply create a summary text that includes the text for each of passages 123 in the same order in which they occurred in original work 122. In other examples, summary service 101 may reorder at least a portion of passages 123 into an order that would likely make more sense to a user (e.g., if original work 122 jumps back and forth in time, passages 123 may be reordered chronologically). In yet other examples, summary service 101 may augment and/or amend passages 123 with text to make summary 124 more stylistically proper. For instance, summary service 101 may add a transition sentence between two passages for better flow when read by a user. Other manners of combining passages 123 may also be used. In some examples, summary service 101 may be restricted in how long a summary can be. The combination of passages 123 may therefore be dependent upon ensure summary 124 not exceed that defined length (e.g., summary service 101 may determine to drop certain ones of passages 123 to shorten summary 124).

In examples, where an entailment tree is created, summary service 101 may pick and choose passages of passages 123 from the entailment tree depending on, for example, a level of detail or length requirement. That is, since passages further along in the tree tend to provide more information than previous passages, a summary requiring more detail would use passages further along in the tree. Additionally, using an entailment tree allows for multiple summaries to be more easily created by accessing the already created entailment tree. For example, summary service 101 may have reason to provide a summary of one level of detail for one user while providing a summary of a different level of detail to another user. Summary service 101 would simply access the entailment tree to create both summaries rather than having to fully process original work 122 twice (i.e., once for each summary).

Once summary 124 has been created, summary service 101 presents summary 124 to user 131 (203). If summary service 101 has a user interface for user 131 to interact with (e.g., comprises a user device operated by user 131), the summary service 101 will present summary 124 directly to user 131. Otherwise, summary service 101 presents summary 124 by transferring summary 124 to a user device that does have a user interface accessible by user 131. Summary 124 may be presented by displaying the text of summary 124 to user 131 or audibly reproducing the text of summary 124. Summary service 101 may present summary 124 automatically upon creating summary 124, may present summary 124 upon request from user 131, or may present summary 124 at some other time.

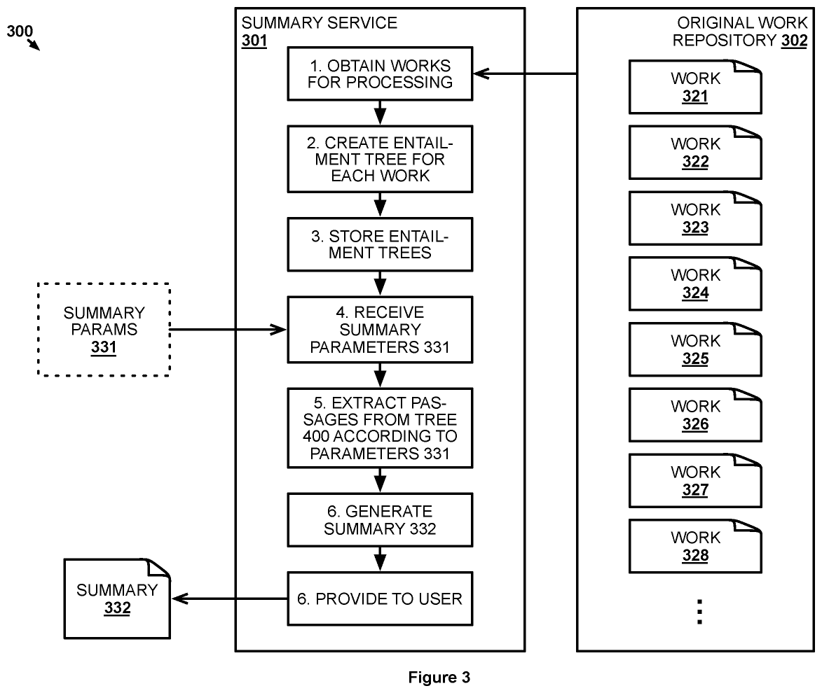

FIG. 3 illustrates operational scenario 300 for summarizing an original work using text entailment. In operational scenario 300, summary service 301, which is similar to summary service 101, generates summaries of original works obtained from original work repository 302, which is similar to original work repository 102. Summary service 301 and original work repository 302 may communicate over one or more communication networks, including the Internet, even though such networks are not shown in operational scenario 300. While summary service 301 only summarizes original works from original work repository 302 in this example, summary service 301 may summarize original works from other repositories in addition to those from original work repository 302. A user may indicate to summary service 301 from which of the repositories summary service 301 should obtain original works for summary. The user may further indicate characteristics (e.g., category, author, publication date, key words, etc.) of the original works that should be obtained so that summary service 301 does not need to process all works available from a particular repository. For example, original work repository 302 may be a particular news website and the user may indicate to summary service 301 that only works in the world news category should be summarized and may indicate that, in additional to all world news articles that are published to the news website going forward, summary service 301 should summarize world news articles up to 5 years old that are available on the site.

In operational scenario 300, summary service 301 obtains original works original works 321-328 from original work repository 302 at step 1 for processing. Summary service 301 may monitor original work repository 302 (e.g., make periodic checks) for new works (either all works or only those having predefined characteristics), may query original work repository 302 for original works that have predefined characteristics, may configure original work repository 302 to automatically transfer original works to summary service 301 (e.g., subscribe to a work provision function), or summary service 301 perform of some other method of retrieving information from another system—including combinations thereof. Since summary service 301 may not retrieve all of original works 321-328 at one time, subsequent steps 2 and 3 in operational scenario 300 described below may occur as summary service 301 continues to obtain additional works for processing. As more original works are obtained by summary service 301, summary service 301 may perform steps 2 and 3 with respect to those works.

For each of original works 321-328, summary service 301 at step 2 feeds the original work into a text entailment algorithm and the text entailment algorithm outputs a tree structure, an entailment tree, for all the entailment relationships discovered in the original work. Summary service 301 may be able to process one or more of original works 321-328 in parallel using the text entailment algorithm or may process original works 321-328 in series. The entailment tree is stored by summary service 301 at step 3 either within summary service 301 or in a storage system accessible by summary service 301 (e.g., a networked or cloud storage system). After all of original works 321-328 are processed, summary service 301 will have stored eight entailment trees that each correspond to one of original works 321-328. The entailment algorithm itself may output entailed passage combinations in tree form or summary service 301 may organize the output combinations into tree form (i.e., may recognize that one the hypothesis of one combination is also the text of another and creates a branch of the tree accordingly).

In this example, the entailment trees are created before a summary request is received for any of the corresponding original works 321-328. In other examples, an entailment tree for a particular original work may not be created until after a request for a summary of that work is received. Even in those cases, the entailment tree may then be stored by summary service 301 so that the entailment tree does not need to be re-created should another request for a summary of the original work be received. Summary service 301 may store the entailment trees indefinitely or may delete the entailment trees after a period of time, which would conserve storage space for older original works that are less likely to be the subject of a summary request.

Summary service 301 receives a request for a summary 332 of original work 322 at step 4 in the form of summary parameters 331. In this example, summary parameters 331 are received from a user, although other examples may have summary service 301 receive summary parameters 331 from another system. The user may provide summary parameters 331 directly to summary service 301 through a user interface of summary service 301 or may operate a user system having a user interface into which the user inputs summary parameters 331. In some examples, summary service 301 may be a cloud-based service operating on one or more servers accessible by the user system over communication networks, such as the Internet. The user, likely in addition to other users, may subscribe or otherwise pay for summary service 301 to provide summaries of original works.

Summary parameters 331 indicate that original work 322 is the original work for summarization and a requested length for summary 332 (e.g., a number of sentences, paragraphs, pages, or other manner of designating a length). The requested length may be a desired length, which allows summary 332 to be within a given threshold of the requested length, or the requested length may designate an absolute minimum and/or maximum length that original work 322 is required to be. Typically, the longer a summary is allowed to be, the more details can be included in the summary. In other examples, additional parameters may be included in summary parameters 331, such as limiting the words that can be used in the summary (e.g., create a summary that can be read at particular reading level). In yet other examples, summary parameters 331 may define a level of detail rather than a summary length to ensure the desired detail level is met regardless of summary length. In some cases, summary parameters 331 may indicate other original works that should also be summarized along with lengths for those additional original works. Summary service 301 uses summary parameters 331 to identify entailment tree 400 as corresponding to original work 322 and as a basis to extract passages from entailment tree 400 at step 5 for generating summary 332.

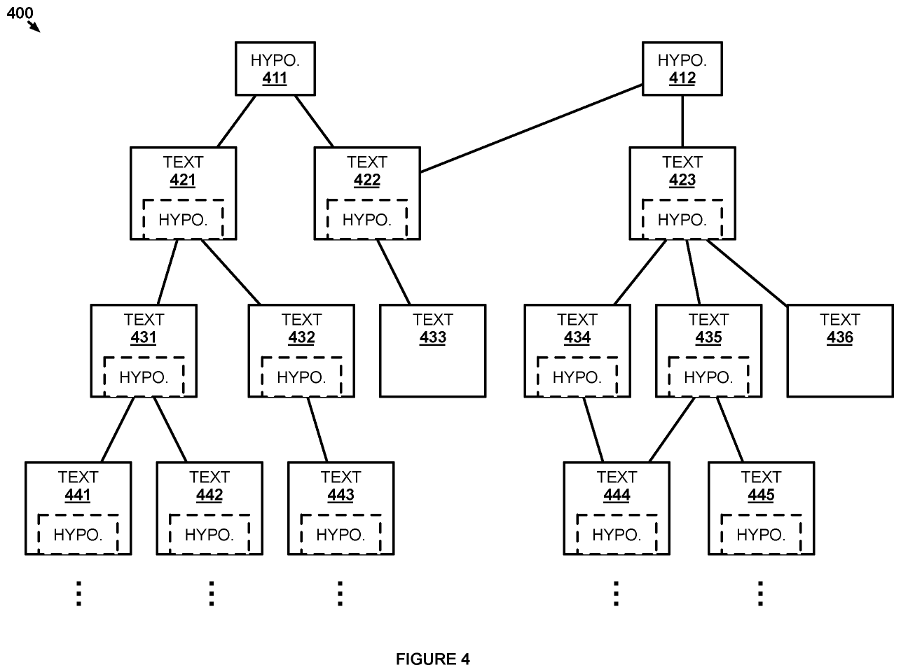

FIG. 4 illustrates entailment tree 400 for summarizing an original work using text entailment. As mentioned above, entailment tree 400 is an entailment tree created by summary service 301. Four levels are shown for entailment tree 400, although more levels may exist. Entailment tree 400 includes two hypothesis passages, hypothesis passage 411 and hypothesis passage 412, as root nodes. Other examples of entailment trees may include any number of two or more levels depending on how many subsequent entailment combinations were found in a processed original work. Likewise, other examples may include any number of one or more root nodes depending on how many hypothesis passages are found by the entailment algorithm that do not branch from one or more text passages.

Entailment tree 400 includes root nodes comprising hypothesis passage 411 and hypothesis passage 412. Hypothesis passage 411 is satisfied by text passage 421 and text passage 422. Hypothesis passage 412 is also satisfied by text passage 422, which is shown as text passage 422 branching from both hypothesis passage 411 and hypothesis passage 412. Text passages 421-423 are then considered hypothesis passages for respective text passages 431-436 at the next level of entailment tree 400. Likewise, text passages 431-432 and 434-435 are then considered hypothesis passages for respective text passages 441-445 at the next level of entailment tree 400. In this example, summary service 301 did not find any passages for which text passage 433 and text passage 436 would be considered a hypothesis passage. Thus, no branches stem below text passage 433 and text passage 436.

Revisiting an example from above, text passage 432 may be the passage that recites “a tornado went through the town of Smallville” and text passage 421 is the hypothesis passage reciting that “the town of Smallville was damaged.” If the aforementioned example for text passage 432 was used as the hypothesis passage for text passage 443, then text passage 443 in this example may be “residents of Smallville reported what looked like a funnel cloud, about the width of a football field, near Main Street in Smallville.” The other text passage and hypothesis passage combinations in entailment tree 400 will cover additional aspects of summary 332 from which entailment tree 400 was generated. As illustrated by the above example, lower passages in entailment tree 400 provide more detail than those above, which are closer to the root. Specifically, passage 421 provides that Smallville was damaged while passage 432 provides that a tornado is what caused at least some of the damage. Passage 443 then provides additional detail about the size of the tornado (i.e., that the tornado was as wide as a football field).

Referring back to operational scenario 300, when summary service 301 extracts passages from entailment tree 400 for use in summarizing original work 322, determines passages needed to satisfy the requested length in summary parameters 331. For example, summary service 301 may determine that passages 411-412, 421-423, and 431-436 create a summary of the appropriate length. Passages 441-445 and any passages below passages 441-445 in entailment tree 400 would, therefore, not be included in summary 332. If summary service 301 receives a different request to summarize original work 322 that requests a longer summary, then passages 441-445 may be included in that summary.

After extracting the passages for entailment tree 400, summary service 301 generates summary 332 at step 6 from those passages. Generating summary 332 may be performed by at least appending combinations of text and hypothesis passages next to one another in a group. Groups text and hypothesis passages may then be appended in temporal order (e.g., in the order in which the passages occurred in original work 322 or in the order in which the passages occurred in a storyline within original work 322), or some other order that would makes sense to a reader and would not skew the interpretation beyond what was intended by the author of original work 322. In other examples, summary service 301 may add appropriate punctuation, transition words, or otherwise modify the passages to enhance the readability of summary 332. Again, using the Smallville example, summary service 301 may form a portion of summary 332 by simply reciting, “A tornado went through the town of Smallville. The town of Smallville was damaged.” In other examples, summary service 301 may combine those two sentences into one by placing an “and” between the sentences or by swapping the order and placing a “because” between the sentences.

Summary service 301 then provides summary 332 to the user at step 6 in response to the request with summary parameters 331. Summary 332 may be provided in a proprietary format or may be provided in a more text document format (e.g., the Portable Document Format). In some examples, summary 332 may be attached or otherwise sent through a messaging application, such as email, instant messaging, or some other information transfer application. In some examples, summary service 301 may be accessed via a website frontend through which summary parameters 331 are provided and by which summary 332 is presented to the requesting user. The user may be given the option to save summary 332 to their user system after presentation through the website. Other manners of requesting information and receiving the requested information may also be used.

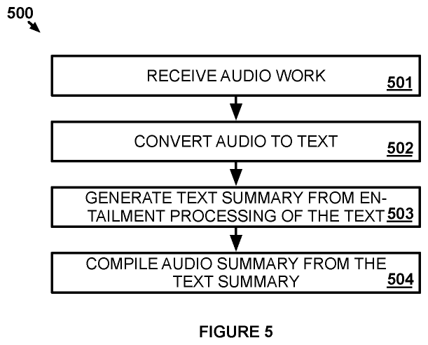

FIG. 5 illustrates operation 500 to summarize original work using text entailment. Operation 500 is performed by summary service 301 to summarize a work that is not natively in a text format. Summary service 301 receives an audio work from original work repository 302 in this example (501). The audio work may be an audio only work, such as a radio show or podcast, or the audio work may be a component of a work that includes more than just audio (e.g., the audio work may be the audio track of a video work). Summary service 301 uses speech recognition to convert the audio to text (502). In examples where the audio work is part of a video work, the video work may include subtitles (e.g., for closed captioning or for those who speak different languages) that summary service 301 can extract rather than having to process the audio work to obtain text.

Once summary service 301 has a text version of the audio work, that text version is, essentially, like any other original work processed by summary service 301. As such, summary service 301 generates a summary using the same text processing described above for original works that were originally in text format (503). In some examples, the text summary that is generated may be provided to a requestor. However, in this example, summary service 301 identifies clips of the audio work that correspond to the text used in the summary and compiles an audio version of the summary by splicing together those clips (504). For example, if the text summary recited “A tornado went through the town of Smallville. The town of Smallville was damaged.”, audio clips that include audio of a person (not necessarily the same person) speaking each of the sentences would be identified and spliced together. In examples where the audio work is part of a video work, the corresponding video clips may be included with the spliced audio. In other examples, summary service 301 may simply use text-to-speech to audibly reproduce the summarized text rather than using clips of the original audio work.

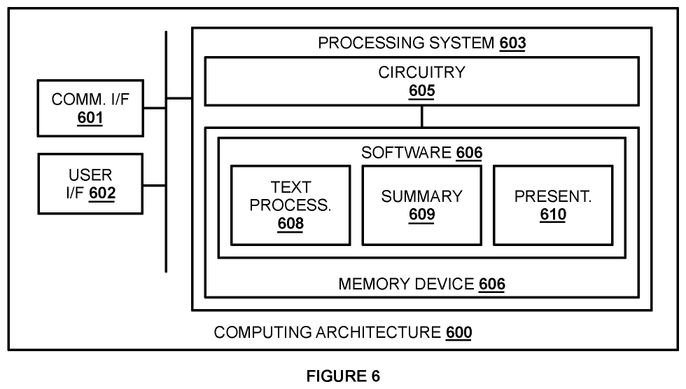

FIG. 6 illustrates computing architecture 600 for summarizing an original work using text entailment. Computing architecture 600 is representative of any computing system or systems with which the various operational architectures, processes, scenarios, and sequences disclosed herein for an event summary service may be implemented. Computing architecture 600 is an example of computer systems implementing summary service 101, although other examples may exist. Computing architecture 600 comprises communication interface 601, user interface 602, and processing system 603. Processing system 603 is linked to communication interface 601 and user interface 602. Processing system 603 includes processing circuitry 605 and memory device 606 that stores operating software 607. Computing architecture 600 may include other well-known components such as a battery and enclosure that are not shown for clarity.

Communication interface 601 comprises components that communicate over communication links, such as network cards, ports, radio frequency (RF), processing circuitry and software, or some other communication devices. Communication interface 601 may be configured to communicate over metallic, wireless, or optical links. Communication interface 601 may be configured to use Time Division Multiplex (TDM), Internet Protocol (IP), Ethernet, optical networking, wireless protocols, communication signaling, or some other communication format—including combinations thereof. In some implementations, communication interface 601 may be configured to communicate with information and supplemental resources to obtain objects for defining events. Communication interface 601 may further be configured to communicate with client or console devices of end users, wherein the users may request and receive summaries from computing system

User interface 602 comprises components that interact with a user to receive user inputs and to present media and/or information. User interface 602 may include a speaker, microphone, buttons, lights, display screen, touch screen, touch pad, scroll wheel, communication port, or some other user input/output apparatus—including combinations thereof. User interface 602 may be omitted in some examples. In some implementations, user interface 602 may be used in obtaining user summary requests and providing the summary to the requesting user.

Processing circuitry 605 comprises microprocessor and other circuitry that retrieves and executes operating software 607 from memory device 606. Memory device 606 may include volatile and nonvolatile, removable and non-removable media implemented in any method or technology for storage of information, such as computer readable instructions, data structures, program modules, or other data. Memory device 606 may be implemented as a single storage device but may also be implemented across multiple storage devices or sub-systems. Memory device 606 may comprise additional elements, such as a controller to read operating software 607. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. It should be understood that in no case is the storage media a propagated signal.

Processing circuitry 605 is typically mounted on a circuit board that may also hold memory device 606 and portions of communication interface 601 and user interface 602. Operating software 607 comprises computer programs, firmware, or some other form of machine-readable program instructions. Operating software 607 includes text processing module 608, summary module 609, and presentation module 610, although any number of software modules may provide the same operation. Operating software 607 may further include an operating system, utilities, drivers, network interfaces, applications, or some other type of software. When executed by processing circuitry 605, operating software 607 directs processing system 603 to operate computing architecture 600 as described herein.

In one implementation, text processing module 608 directs processing system 603 to process a first original work using a text entailment algorithm. The text entailment algorithm outputs passages of the first original work that are most informative relative to other passages. Summary module 609 directs processing system 603 to combine the passages into a summary of the first original work. Presentation module 610 directs processing system 603 to present the summary to a user.

The descriptions and figures included herein depict specific implementations of the claimed invention(s). For the purpose of teaching inventive principles, some conventional aspects have been simplified or omitted. In addition, some variations from these implementations may be appreciated that fall within the scope of the invention. It may also be appreciated that the features described above can be combined in various ways to form multiple implementations. As a result, the invention is not limited to the specific implementations described above, but only by the claims and their equivalents.

What is claimed is:

1. A method for summarizing of an original work, the method comprising:
processing a first original work using a text entailment algorithm, wherein the text entailment algorithm outputs passages of the first original work that are most informative relative to other passages;
combining the passages into a summary of the first original work; and
presenting the summary to a user.

2. The method of claim 1, further comprising:
receiving summary parameters that are used as a basis for combining the passages into the summary.

3. The method of claim 2, wherein the summary parameters include a limit on the length of the summary

4. The method of claim 1, further comprising:
organizing the passages into an entailment tree structure connecting hypothesis passages to text passages.

5. The method of claim 4, wherein hypothesis and text passage combinations that are nearer to a root node of the tree are less detailed than hypotheses and text passage combinations that are farther down from the root node.

6. The method of claim 5, wherein combining the passages into the summary comprises:
for a shorter summary, selecting one or more of the hypothesis and text passage combinations that are nearer to the root node; and
for a longer summary, selecting one or more of the hypothesis and text passage combinations that are farther down the root node.

7. The method of claim 6, wherein combining the passages into the summary further comprises:
appending selected hypothesis and text passage combinations to one another and other selected hypothesis and text passages.

8. The method of claim 7, wherein combining the passages into the summary further comprises:
adding punctuation to the selected hypothesis and text passages.

9. The method of claim 1, further comprising:
before processing the first original work, converting the first original work from an audio format to a text format.

10. The method of claim 9, further comprising:
converting the summary from the text format to the audio format before presenting the summary.

11. One or more computer readable storage media having program instructions stored thereon for improved summarization of an original work, the program instructions, when read and executed by the processing system, direct the processing system to:
process a first original work using a text entailment algorithm, wherein the text entailment algorithm outputs passages of the first original work that are most informative relative to other passages;
combine the passages into a summary of the first original work; and
present the summary to a user.

12. The one or more computer readable storage media of claim 11, wherein the program instructions further direct the processing system to:
receive summary parameters that are used as a basis for combining the passages into the summary.

13. The one or more computer readable storage media of claim 12, wherein the summary parameters include a limit on the length of the summary

14. The one or more computer readable storage media of claim 11, wherein the program instructions further direct the processing system to:
organize the passages into an entailment tree structure connecting hypothesis passages to text passages.

15. The one or more computer readable storage media of claim 14, wherein hypothesis and text passage combinations that are nearer to a root node of the tree are less detailed than hypotheses and text passage combinations that are farther down from the root node.

16. The one or more computer readable storage media of claim 15, wherein to combine the passages into the summary, the program instructions direct the processing system to:
for a shorter summary, select one or more of the hypothesis and text passage combinations that are nearer to the root node; and
for a longer summary, select one or more of the hypothesis and text passage combinations that are farther down the root node.

17. The one or more computer readable storage media of claim 16, wherein to combine the passages into the summary, the program instructions further direct the processing system to:
append selected hypothesis and text passage combinations to one another and other selected hypothesis and text passages.

18. The one or more computer readable storage media of claim 17, wherein to combine the passages into the summary, the program instructions further direct the processing system to:
add punctuation to the selected hypothesis and text passages.

19. The one or more computer readable storage media of claim 11, wherein the program instructions further direct the processing system to:
before processing the first original work, converting the first original work from an audio format to a text format; and
converting the summary from the text format to the audio format before presenting the summary.

20. An apparatus for improved summarization of an original work, the apparatus comprising:
one or more computer readable storage media;
a processing system operatively coupled with the one or more computer readable storage media; and
program instructions stored on the one or more computer readable storage media that, when read and executed by the processing system, direct the processing system to:
process a first original work using a text entailment algorithm, wherein the text entailment algorithm outputs passages of the first original work that are most informative relative to other passages;
combine the passages into a summary of the first original work; and
present the summary to a user.
